(19) United States
(12) Patent Application Publication
(10) Pub. No.: US 2024/0294681 A1
(43) Pub. Date: Sep. 5, 2024

(54) IMPROVING CATALYST PERFORMANCE IN MULTI-STAGE POLYOLEFIN PRODUCTION

(71) Applicant: BOREALIS AG, Vienna (AT)

(72) Inventors: Vasileios KANELLOPOULOS, Linz (AT); Joana Elvira KETTNER, Linz (AT); Matthias HOFF, Linz (AT); Apostolos KRALLIS, Porvoo (FI); Victor SUMERIN, Porvoo (FI); Jani AHO, Porvoo (FI); Kalle KALLIO, Porvoo (FI); Irfan SAEED, Porvoo (FI); Erno ELOVAINIO, Porvoo (FI)

(21) Appl. No.: 18/572,405

(22) PCT Filed: Jun. 23, 2022
(86) PCT No.: PCT/EP2022/067183

§ 371 Date: Dec. 20, 2023

(30) Foreign Application Priority Data
Jun. 24, 2021 (EP) 21181473.6

(51) Int. Cl. C08F 210/16; C08F 2/00; C08F 2/01; C08F 2/34; C08F 2/38; C08F 4/6592

(52) U.S. Cl. CPC C08F 210/16; C08F 2/001; C08F 2/01; C08F 2/34; C08F 2/38; C08F 4/6592

(57) ABSTRACT

The disclosure relates to a process for polymerising olefins in multi stage polymerisation process configuration, the process comprising a) polymerising in a first polymerisation step first olefin monomer, optionally in the presence of at least one other alpha olefin comonomer, in the presence of a metallocene polymerisation catalyst so as to form a first polymer component (A); and b) transferring the first polymer component (A) into a separation unit to remove low molecule penetrants and to obtain separated solid polyolefin particles of the first polymer component (A*) and c) polymerising in in gas phase in a second polymerisation step second olefin monomer, optionally in the presence of at least one other alpha olefin comonomer in the presence of the separated solid polyolefin particles (A*) of step b), so as to form a second polymer component (B). The disclosure further relates to a method for improving performance of a metallocene polymerisation catalyst in a multi-stage olefin polymerisation, wherein a first polymer component (A) produced in a first polymerisation step is transferred into a separation unit to remove low molecule penetrants and to obtain separated solid polyolefin particles of the first polymer component (A*) prior to transferring the obtained separated solid polyolefin particles of the first polymer component (A*) to a further polymerisation step.

### FIELD OF THE DISCLOSURE

The present disclosure relates to copolymerisation of olefins, and more particularly to a multi-stage polyolefin production process. The present disclosure further concerns a method for improving the performance of a metallocene polymerisation catalyst by selecting flashing operating conditions of the high-pressure flash that is employed to remove the unreacted components and diluents form polymer particles before they enter to the subsequent polymerisation stage in a multi-stage olefin polymerisation process. It further concerns the influence of the particle size distribution developments in gas phase reactor GPR that in turn could eliminate solids carry over, sheeting and chunking phenomena.

### BACKGROUND OF THE DISCLOSURE

Multi-stage polyolefin production processes (e.g. Borstar PE, PP and Spheripol PP) consist of multi-stage reactor configuration to give the multi-modal capability for achieving easy to process resins with desired mechanical properties. In such processes, a combination of slurry loop reactors in series followed by a gas phase reactor is employed to produce a full range of polyolefins.

One of the key features in multi-stage olefin polymerisation processes is to assure proper catalyst performance in all stages of the multi-stage polymerisation process, and more particularly, appropriate selection of the gas-phase reactor operating conditions that would result in smooth operability in GPR. With single-site catalysts that have superior comonomer incorporation capabilities as compared to the 1^{st} generation ones this may be challenging. Presence of small size particles (also known as Stocke's particles: particles that in gas-solids fluidization environment the buoyancy forces are higher than the gravitational forces) which have the tendency to be entrained by the fluidization gas may cause issues related to reactor fouling (polymer coating on the reactor wall), sheeting and chunking as well as fouling of the circulation gas compressor and the heat exchanger units. In this context, optimizing the catalyst performance in terms of eliminating the population of small-size particles in the GPR is of paramount importance and represents a key aspect to the successful implementation of the catalyst in a multi-stage ethylene copolymerisation process.

### BRIEF DESCRIPTION OF THE DISCLOSURE

An object of the present disclosure is to provide a process for polymerising olefins in multi stage polymerisation process configuration so as to overcome the above problems.

The object of the disclosure is achieved by a process and a method, which are characterized by what is stated in the independent claims. The preferred embodiments of the disclosure are disclosed in the dependent claims.

The disclosure is based on the idea of transferring a first polymer component produced in a first polymerisation step into a separation unit to remove low molecule penetrants and to obtain separated solid polyolefin particles of the first polymer component (A*) before the first polymer component transferred to a second polymerisation step where further polymerisation takes place.

### BRIEF DESCRIPTION OF THE DRAWINGS

In the following the disclosure will be described in greater detail by means of preferred embodiments with reference to the accompanying drawings, in which

FIG. 1 shows an embodiment of the polymerisation process according to the present invention in a fluidized bed reactor with a fluidization grid.

### DETAILED DESCRIPTION OF THE DISCLOSURE

The disclosure relates to a process for polymerising olefins in multi stage polymerisation process configuration, the process comprising
a) polymerising in a first polymerisation step first olefin monomer, optionally in the presence of at least one other alpha olefin comonomer, in the presence of a metallocene polymerisation catalyst so as to form a first polymer component (A); and
b) transferring the first polymer component (A) into a separation unit to remove low molecule penetrants and to obtain separated solid polyolefin particles of the first polymer component (A*) and
c) polymerising in gas phase in a second polymerisation step second olefin monomer, optionally in the presence of at least one other alpha olefin comonomer in the presence of the separated solid polyolefin particles (A*) of step b), so as to form a second polymer component (B).

The present process defines an optimal set of operating conditions (e.g., pressure and residence time of the particulate polymer matter in the high pressure flash separator) during flashing of polyethylene particulate matter in the flash separator located between first and second polymerisation step, e.g. the loop(s) and the GPR, in a multi-stage polymerisation process, so to eliminate the risk of producing fines and achieve high initial polymerisation rate in GPR due to the sorbed 1-butene, thus improving the catalyst performance during the polymerisation process.

The disclosure thus further relates to a method for improving performance of a metallocene polymerisation catalyst in a multi-stage olefin polymerisation process, wherein a first polymer component (A) produced in a first polymerisation step is transferred into a separation unit to remove low molecule penetrants and to obtain separated solid polyolefin particles of the first polymer component (A*) prior to transferring the obtained separated solid polyolefin particles of the first polymer component (A*) to a further polymerisation step.

### Process

The present disclosure relates to a multistage polymerisation process using a metallocene polymerisation catalyst, said process comprising an optional but preferred prepolymerisation step, followed by a first and a second polymerisation step.

Preferably, the same catalyst is used in each step and ideally, it is transferred from prepolymerisation to subsequent polymerisation steps in sequence in a well-known manner. One preferred process configuration is based on a Borstar® type cascade, in particular Borstar® 2G type cascade, preferably Borstar® 3G type cascade.

Accordingly, the present process for polymerising olefins in multi stage polymerisation process configuration, comprises
a) polymerising in a first polymerisation step first olefin monomer, optionally in the presence of at least one other alpha olefin comonomer so as to form a first polymer component (A); and
b) transferring the first polymer component (A) into a separation unit to remove low molecule penetrants and to obtain separated solid polyolefin particles of the first polymer component (A*) and
c) polymerising in gas phase in a second polymerisation step second olefin monomer, optionally in the presence of at least one other alpha olefin comonomer in the presence of the separated solid polyolefin particles of step b), so as to form a second polymer component (B).

Typically the first olefin monomer polymerised in the first polymerisation step and the second olefin monomer polymerised in the second polymerisation step are the same olefin monomer, in particular ethylene. At least one olefin comonomer may optionally be present in either step and it may be the same comonomer in both steps or different or only present in one of the steps as discussed below.

### Prepolymerisation Step

Polymerisation steps may be preceded by a prepolymerisation step. The purpose of the prepolymerisation is to polymerise a small amount of polymer onto the catalyst at a low temperature and/or a low monomer concentration. By prepolymerisation it is possible to improve the performance of the catalyst in slurry and/or modify the properties of the final polymer. The prepolymerisation step is preferably conducted in slurry and the amount of polymer produced in an optional prepolymerisation step is counted to the amount (wt %) of ethylene polymer component (A).

The catalyst components are preferably all introduced to the prepolymerisation step when a prepolymerisation step is present. Preferably the reaction product of the prepolymerisation step is then introduced to the first polymerisation step.

However, where the solid catalyst component and the cocatalyst can be fed separately it is possible that only a part of the cocatalyst is introduced into the prepolymerisation stage and the remaining part into subsequent polymerisation stages. Also in such cases it is necessary to introduce so much cocatalyst into the prepolymerisation stage that a sufficient polymerisation reaction is obtained therein.

It is understood within the scope of the invention, that the amount or polymer produced in the prepolymerisation lies within 1 to 7 wt % in respect to the final multimodal copolymer. This can counted as part of the first ethylene polymer component (A) produced in the first polymerisation step a).

### First Polymerisation Step a)

In the present process the first polymerisation step a) involves polymerising olefin monomer and optionally at least one olefin comonomer.

In one embodiment the first polymerisation step involves polymerising ethylene to produce ethylene homopolymer.

In another embodiment the first polymerisation step involves polymerising ethylene and at least one olefin comonomer to produce ethylene copolymer.

The first polymerisation step may take place in any suitable reactor or series of reactors. The first polymerisation step may take place in one or more slurry polymerisation reactor(s) or in a gas-phase polymerisation reactor, or a combination thereof. Preferably the first polymerisation step takes place in one or more slurry polymerisation reactor(s), more preferably in at least three slurry-phase reactors including a slurry-phase reactor for carrying out pre-polymerisation.

The polymerisation in the first polymerisation zone is preferably conducted in slurry. Then the polymer particles formed in the polymerisation, together with the catalyst fragmented and dispersed within the particles, are suspended in the fluid hydrocarbon. The slurry is agitated to enable the transfer of reactants from the fluid into the particles.

The slurry polymerisation usually takes place in an inert diluent, typically a hydrocarbon diluent such as methane, ethane, propane, n-butane, isobutane, pentanes, hexanes, heptanes, octanes etc., or their mixtures. Preferably the diluent is a low-boiling hydrocarbon having from 1 to 4 carbon atoms or a mixture of such hydrocarbons. An especially preferred diluent is propane, possibly containing minor amount of methane, ethane and/or butane.

The ethylene content in the fluid phase of the slurry may be from 2 to about 50% by mole, preferably from about 3 to about 20% by mole and in particular from about 5 to about 15% by mole. The benefit of having a high ethylene concentration is that the productivity of the catalyst is increased but the drawback is that more ethylene then needs to be recycled than if the concentration was lower.

The temperature in the slurry polymerisation is typically from 50 to 115° C., preferably from 60 to 110° C. and in particular from 70 to 100° C. The pressure is from 1 to 150 bar, preferably from 10 to 100 bar.

The pressure in the first polymerisation step is typically from 35 to 80 bar, preferably from 40 to 75 bar and in particular from 45 to 70 bar.

The residence time in the first polymerisation step is typically from 0.15 h to 3.0 h, preferably from 0.20 h to 2.0 h and in particular from 0.30 to 1.5 h.

It is sometimes advantageous to conduct the slurry polymerisation above the critical temperature and pressure of the fluid mixture. Such operation is described in U.S. Pat. No. 5,391,654. In such operation the temperature is typically from 85 to 110° C., preferably from 90 to 105° C. and the pressure is from 40 to 150 bar, preferably from 50 to 100 bar.

The slurry polymerisation may be conducted in any known reactor used for slurry polymerisation. Such reactors include a continuous stirred tank reactor and a loop reactor. It is especially preferred to conduct the polymerisation in loop reactor. In such reactors the slurry is circulated with a high velocity along a closed pipe by using a circulation pump. Loop reactors are generally known in the art and examples are given, for instance, in U.S. Pat. Nos. 4,582,816, 3,405,109, 3,324,093, EP-A-479186 and U.S. Pat. No. 5,391,654.

The slurry may be withdrawn from the reactor either continuously or intermittently. A preferred way of intermittent withdrawal is the use of settling legs where slurry is allowed to concentrate before withdrawing a batch of the concentrated slurry from the reactor. The use of settling legs is disclosed, among others, in U.S. Pat. Nos. 3,374,211, 3,242,150 and EP-A-1310295. Continuous withdrawal is disclosed, among others, in EP-A-891990, EP-A-1415999, EP-A-1591460 and WO-A-2007/025640. The continuous withdrawal is advantageously combined with a suitable concentration method, as disclosed in EP-A-1310295, EP-A-1591460, and EP3178853B1.

Hydrogen may be fed into the reactor to control the molecular weight of the polymer as known in the art. Furthermore, one or more alpha-olefin comonomers may be added into the reactor to control the density of the polymer product. The actual amount of such hydrogen and comonomer feeds depends on the catalyst that is used and the desired melt index (or molecular weight) and density (or comonomer content) of the resulting polymer.

Hydrogen may be fed into the reactor to control the molecular weight of the polymer as known in the art. Furthermore, one or more alpha-olefin comonomers may be added into the reactor to control the density of the polymer product. The actual amount of such hydrogen and comonomer feeds depends on the catalyst that is used and the desired melt index (or molecular weight) and density (or comonomer content) of the resulting polymer.

### Separation Step b)

The term “low molecule penetrant” refers to C2-6-hydrocarbons, in particular to alpha C2-6-olefins (e.g. ethylene, 1-butene, 1-hexene), and C2-6-alkanes (e.g. propane), and chain transfer agents (e.g. hydrogen).

The obtained separated solid polyolefin particles exhibit a particle size distribution having a mean particle size (D50) between 100 μm to 600 μm, preferably between 120 μm to 550 μm, most preferably between 150 μm to 500 μm and span (span: (d90−d10)/d50)) between 0.8 to 3.5, more preferably between 1.0 to 2.5. most preferably between 1.2 to 2.0. The concentration of the unreacted components, diluents and chain transfer agents in the polymer particles is between 1*10⁻⁶ g/gampol (grams of component per gram of amorphous polymer) to 0.9 g/gpol, more preferably between 1*10⁻⁵ g/gampol to 0.8 g/gampol, most preferably, between 5*10⁻⁵ g/gampol to 0.7 g/gampol

The separation step may be conducted in any known separator used for removing volatile hydrocarbons from solids. Such units include flash separator.

The operating pressure of the separation unit, in particular the flash separator, is within the range of 1 to 25 bar, preferably from 2 to 22 bar, more preferably from 3 to 20 bar.

The operating temperature of the separation unit, in particular the flash separator, is within the range of 40 to 90° C., preferably from 50 to 85° C., more preferably from 60 to 80° C.

The average residence time of the particulate matter in the separation unit, in particular the flash separator, is within the range of 2 to 30 min, preferably from 3 to 25 min, more preferably from 5 to 20 min.

The residual 1-butene concentration of the polymer particles that leave the loop reactor and enter the gas phase reactor has been surprisingly found to be a key factor in determining the initial particle growth rate in GPR, especially when ‘comonomer sensitive’ single-site polyethylene catalysts are employed in the process. Additionally, operating the flash separator at elevated pressures contributes in maintaining high comonomer concentration in the polymer particles and at the same time lessens the stresses that are developed in the polymer particles due to the pressure difference between the operating pressures in the loop and the flash separator. This leads to the conclusion that the flashing conditions in the high-pressure flash play important role in determining the particle size distribution in the gas phase that are associated to operability challenges such as sheeting, chunking and excessive solids carry over.

### Second Polymerisation Step c)

From the first polymerisation step a) the first polymer component (A) is transferred via the separation step b) to the second polymerisation step c) as separated solid polyolefin particles (A*).

In the present process, the second polymerisation step c) involves polymerising olefin monomer and optionally at least one olefin comonomer. The olefin monomer of the second polymerisation step b) i.e. the second olefin monomer is typically the same as the olefin monomer of the first polymerisation step a) i.e. the first olefin monomer. Preferably, the olefin monomer is ethylene.

In one embodiment the second polymerisation step involves polymerising ethylene and optionally at least one olefin comonomer to produce ethylene homopolymer or ethylene copolymer, respectively.

The second polymerisation step takes place in one or more gas phase polymerisation reactor(s).

The gas phase polymerisation may be conducted in any known reactor used for gas phase polymerisation. Such reactors include a fluidized bed reactor, a fast fluidized bed reactor or a settled bed reactor or in any combination of these. When a combination of reactors is used then the polymer is transferred from one polymerisation reactor to another. Furthermore, a part or whole of the polymer from a polymerisation stage may be returned into a prior polymerisation stage.

The gas phase polymerisation is conducted in gas-solids fluidized beds, also known as gas phase reactors (GPR). Gas solids olefin polymerisation reactors are commonly used for the polymerisation of alpha-olefins such as ethylene and propylene as they allow relative high flexibility in polymer design and the use of various catalyst systems. A common gas solids olefin polymerisation reactor variant is the fluidized bed reactor.

In the gas-solids olefin polymerisation reactor polymerisation is conducted using gaseous olefin monomer(s) in which the polymer particles are growing.

The present process is suitable for any kind of gas-solids olefin polymerisation reactors suitable for the polymerisation of alpha-olefin homo- or copolymers. Suitable reactors are e.g. continuous-stirred tank reactors or fluidized bed reactors. Both types of gas-solids olefin polymerisation reactors are well known in the art.

Preferably the gas-solids olefin polymerisation reactor is a fluidized bed reactor.

In a fluidized bed reactor the polymerisation takes place in a fluidized bed formed by the growing polymer particles in an upwards moving gas stream. In the fluidized bed the polymer particles, containing the active catalyst, come into contact with the reaction gases, such as monomer, comonomer(s) and hydrogen which cause polymer to be produced onto the particles.

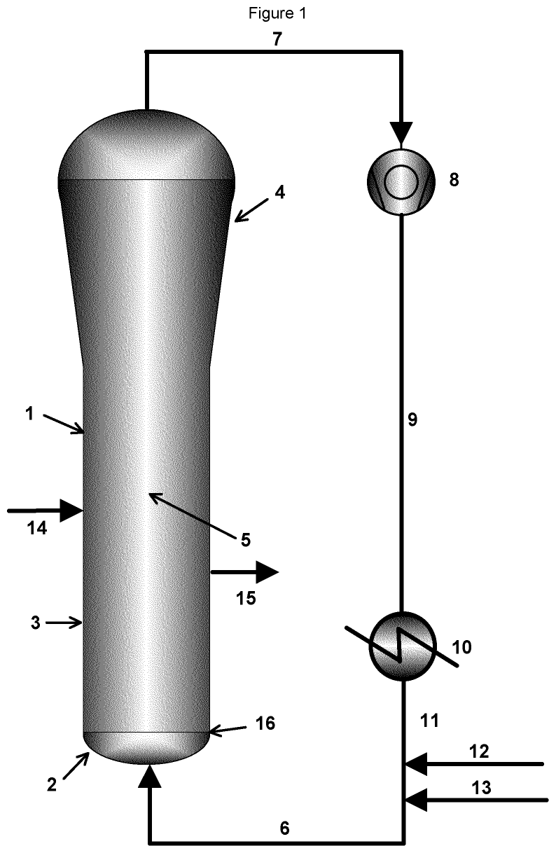

Thereby, in one preferred embodiment the fluidized bed reactor can comprise a fluidization grid which is situated below the fluidized bed thereby separating the bottom zone and the middle zone of the reactor. The upper limit of the fluidized bed is usually defined by a disengaging zone in which due to its expanding diameter compared to the middle zone the fluidization gas expands and the gas disengages from the polyolefin powder. Fluidized bed reactors with disengaging zone and fluidization grid are well known in the art. Such a fluidized bed reactor suitable for the process of the present invention is shown in FIG. 1.

In another preferred embodiment the fluidized bed reactor does not comprise a fluidization grid. The polymerisation takes place in a reactor including a bottom zone, a middle zone and a top zone. The bottom zone, which has a generally conical shape, forms the lower part of the reactor in which the base of the fluidized bed is formed. The base of the bed forms in the bottom zone with no fluidization grid, or gas distribution plate, being present. Above the bottom zone and in direct contact with it is the middle zone, which has a generally cylindrical shape. The middle zone and the upper part of the bottom zone contain the fluidized bed. Because there is no fluidization grid there is a free exchange of gas and particles between the different regions within the bottom zone and between the bottom zone and the middle zone. Finally, above the middle zone and in direct contact therewith is the top zone which has a generally conical shape tapering upwards.

The bottom zone of the reactor has a generally conical shape tapering downwards. Because of the shape of the zone, the gas velocity gradually decreases along the height within said bottom zone. The gas velocity in the lowest part is greater than the transport velocity and the particles eventually contained in the gas are transported upwards with the gas. At a certain height within the bottom zone the gas velocity becomes smaller than the transport velocity and a fluidized bed starts to form. When the gas velocity becomes still smaller the bed becomes denser and the polymer particles distribute the gas over the whole cross-section of the bed. Such a fluidized bed reactor without fluidization grid is described in EP-A-2 495 037, EP-A-2 495 038, EP3103818B1, EP2913346B1, EP3418308B1, and EP3642246B1.

In a gas solids olefin polymerisation reactor the upwards moving gas stream is established by withdrawing a fluidization gas stream as second gas stream from the top zone of the reactor, typically at the highest location. The second gas stream withdrawn from the reactor is then usually cooled and re-introduced to the bottom zone of the reactor as first stream of fluidization gas. In a preferred embodiment, the fluidization gas of the second gas stream is also compressed in a compressor. More preferably, the compressor is located upstream of the cooler. Preferably, the gas is filtered before being passed to the compressor. Additional olefin monomer(s), eventual comonomer(s), hydrogen and inert gas are suitably introduced into the circulation gas line. It is preferred to analyze the composition of the circulation gas, for instance, by using on-line gas chromatography and adjust the addition of the gas components so that their contents are maintained at desired levels.

The temperature in the gas phase polymerisation is typically from 50 to 100° C., preferably from 65 to 90° C.

The pressure in the gas phase polymerisation is typically from 5 to 40 bar, preferably from 10 to 35 bar, preferably from 15 to 30 bar.

The residence time in the gas phase polymerisation is from 1.0 h to 4.5 h, preferably from 1.5 h to 4.0 h and in particular from 2.0 to 3.5 h.

The polymer production rate in the gas phase reactor may be from 10 tn/h to 65 tn/h, preferably from 12 tn/h to 58 tn/h and in particular from 13 tn/h to 52.0 tn/h, and thus the total polymer withdrawal rate from the gas phase reactor may be from 15 tn/h to 100 tn/h, preferably from 18 tn/h to 90 tn/h and in particular from 20 tn/h to 80.0 tn/h.

The production split (% second polymer component (B)/% first polymer component (A) may be from 0.65 to 2.5, preferably from 0.8 to 2.3, most preferably from 1.0 to 1.65.

FIG. 1 shows an embodiment of the polymerisation process according to the present invention in a fluidized bed reactor with a fluidization grid.

### REFERENCE SIGNS

1 fluidized bed reactor
2 bottom zone
3 middle zone
4 top zone (disengaging zone)
5 fluidized bed (dense zone)
6 first stream of fluidized gas
7 second stream of fluidized gas
8 compressor
9 compressed second stream of fluidized gas
10 cooler
11 cooled second stream of fluidized gas
12 feeding line for the induced swelling agent
13 feeding line for the fresh monomer, comonomer, chain transfer and diluents
14 feeding port for metallocene polymerisation catalyst
15 polymer withdrawal
16 fluidization grid

### Description of FIG. 1

FIG. 1 shows an embodiment of the gas solids olefin polymerisation reactor system according to the present invention. The fluidized bed reactor (1) comprises a bottom zone (2), a middle zone (3) and a disengaging zone as top zone (4). The middle zone (3) and the bottom zone (2) are separated by the fluidization grid (16). The first stream of fluidized gas (6) enters the fluidized bed reactor (1) through the bottom zone (2) and flows upwards, thereby passing the fluidization grid (16) and entering the middle zone (3). Due to the substantially cylindrical shape of the middle zone (3) the gas velocity is constant so that above the fluidization grid (16) the fluidized bed (5) is established in the middle zone (3). Due to the conical shape of the disengaging zone (4) the gas entering the disengaging zone (4) expands so that the gas disengages from the polyolefin product of the polymerisation reaction so that the fluidized bed (5) is confined in the middle zone (3) and the lower part of the disengaging zone (4). The metallocene polymerisation catalyst together with optional polyolefin powder polymerised in previous polymerisation stage(s) is introduced into the fluidized bed reactor (1) through feeding port (14) directly into the fluidized bed (5). The polyolefin product of the polymerisation process is withdrawn from the fluidized bed reactor through outlet (15).

The fluidized gas is withdrawn from the disengaging zone (4) as second stream of fluidization gas (7) and introduced into a compressor (8). The compressed second stream (9) is withdrawn from the compressor (8) and introduced into a cooler (10). The induced swelling agent is introduced to the second cooled stream (11) via the feeding line (12) and the fresh monomer, comonomers, diluent and chain transfer agents are introduced to the second cooled stream (11) via the feeding line (13).

### Polymerisation Catalyst

The polymerisation catalyst utilized in the present process is a metallocene catalyst. The metallocene polymerisation catalyst typically comprises (i) a transition metal complex, (ii) a cocatalyst, and optionally (iii) a support.

Preferably the first and the second polymerisation step are performed using, i.e. in the presence of, the same metallocene catalyst.

The present process preferably utilizes single-site catalysis. Polyethylene copolymers made using single-site catalysis, as opposed to Ziegler Natta catalysis, have characteristic features that allow them to be distinguished from Ziegler Natta materials. In particular, the comonomer distribution is more homogeneous. This can be shown using TREF or Crystaf techniques. Catalyst residues may also indicate the catalyst used. Ziegler Natta catalysts would not contain a Zr or Hf group (IV) metal for example.

The present invention is particularly important for single-site catalysts due to the low C6 concentration used in the gas phase reactor of the second polymerisation step b).

### Transition Metal Complex (i)

The transition metal complex comprises a transition metal (M) of Group 3 to 10 of the Periodic Table (IUPAC 2007) or of an actinide or lanthanide.

The term “transition metal complex” in accordance with the present invention includes any metallocene or non-metallocene compound of a transition metal, which bears at least one organic (coordination) ligand and exhibits the catalytic activity alone or together with a cocatalyst. The transition metal compounds are well known in the art and the present invention covers compounds of metals from Group 3 to 10, e.g. Group 3 to 7, or 3 to 6, such as Group 4 to 6 of the Periodic Table, (IUPAC 2007), as well as lanthanides or actinides.

In an embodiment, the transition metal complex (i) has the following formula (i-I):

(L)ₘRₙMX_{q} (i-I)
wherein
“M” is a transition metal (M) of Group 3 to 10 of the Periodic Table (IUPAC 2007),
each “X” is independently a monoanionic ligand, such as a σ-ligand,
each “L” is independently an organic ligand which coordinates to the transition metal “M”,
“R” is a bridging group linking said organic ligands (L),
“m” is 1, 2 or 3, preferably 2
“n” is 0, 1 or 2, preferably 0 or 1,
“q” is 1, 2 or 3, preferably 2 and
m+q is equal to the valence of the transition metal (M).
“M” is preferably selected from the group consisting of zirconium (Zr), hafnium (Hf), or titanium (Ti), more preferably selected from the group consisting of zirconium (Zr) and hafnium (Hf). “X” is preferably a halogen, most preferably Cl.

Most preferably, the transition metal complex (i) is a metallocene complex, which comprises a transition metal compound, as defined above, which contains a cyclopentadienyl, indenyl or fluorenyl ligand as the substituent “L”. Further, the ligands “L” may have one or more substituents, such as alkyl groups, aryl groups, arylalkyl groups, alkylaryl groups, silyl groups, siloxy groups, alkoxy groups or other heteroatom groups or the like. Suitable metallocene catalysts are known in the art and are disclosed, among others, in WO-A-95/12622, WO-A-96/32423, WO-A-97/28170, WO-A-98/32776, WO-A-99/61489, WO-A-03/010208, WO-A-03/051934, WO-A-03/051514, WO-A-2004/085499, EP-A-1752462 and EP-A-1739103.

In an embodiment of the invention the metallocene complex is bis(1-methyl-3-n-butylcyclopentadienyl) zirconium (IV) chloride.

In another embodiment, the transition metal complex (i) has the following formula (i-II):

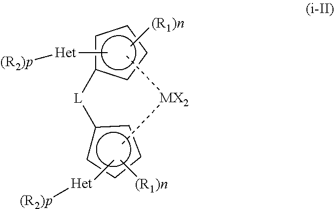

wherein each X is independently a halogen atom, a C1-6-alkyl, C1-6-alkoxy group, phenyl or benzyl group;
each Het is independently a monocyclic heteroaromatic containing at least one heteroatom selected from O or S;
L is-R′2Si—, wherein each R′ is independently C1-20 hydrocarbyl or C1-10 alkyl substituted with alkoxy having 1 to 10 carbon atoms;
M is Ti, Zr or Hf;
each R₁ is the same or different and is a C1-6 alkyl group or C1-6 alkoxy group;
each n is 1 to 2;
each R₂ is the same or different and is a C1-6 alkyl group, C1-6 alkoxy group or —Si(R)3 group;
each R is C1-10 alkyl or phenyl group optionally substituted by 1 to 3 C1-6 alkyl groups; and
each p is 0 to 1.

Preferably, the compound of formula (i-II) has the structure (i-III)

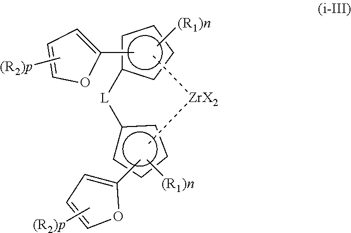

wherein each X is independently a halogen atom, a C1-6-alkyl, C1-6-alkoxy group, phenyl or benzyl group;
L is a Me2Si—;
each R₁ is the same or different and is a C1-6 alkyl group, e.g. methyl or t-Bu;
each n is 1 to 2;
R₂ is a —Si(R)3 alkyl group; each p is 1;
each R is C1-6 alkyl or phenyl group.

Highly preferred transition metal complexes of formula (i-II) are

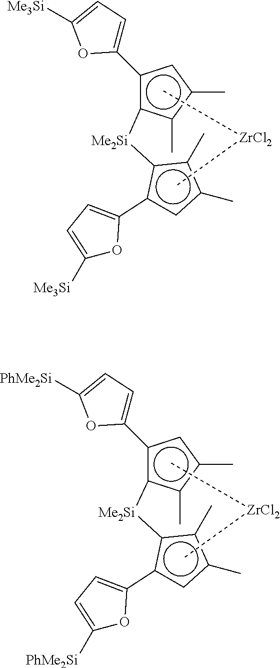

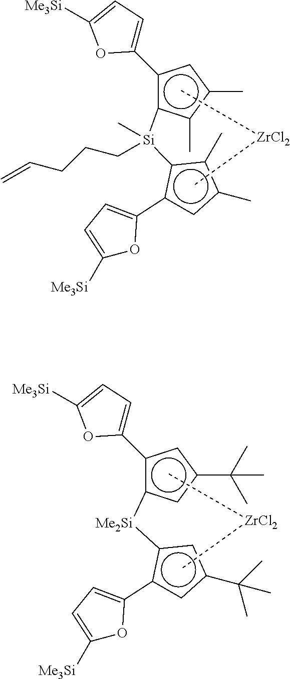

### Cocatalyst (ii)

To form a polymerisation catalyst, a cocatalyst, also known as an activator, is used, as is well known in the art. Cocatalysts comprising Al or B are well known and can be used here. The use of aluminoxanes (e.g. MAO) or boron based cocatalysts (such as borates) is preferred.

Suitable cocatalysts are metal alkyl compounds and especially aluminium alkyl compounds known in the art. Especially suitable activators used with metallocene catalysts are alkylaluminium oxy-compounds, such as methylalumoxane (MAO), tetraisobutylalumoxane (TIBAO) or hexaisobutylalumoxane (HIBAO).

Preferably the cocatalyst is methylalumoxane (MAO).

Support (iii)

It is possible to use the present polymerisation catalyst in solid but unsupported form following the protocols in WO03/051934. The present polymerisation catalyst is preferably used in solid supported form. The particulate support material used may be an inorganic porous support such as a silica, alumina or a mixed oxide such as silica-alumina, in particular silica.

The use of a silica support is preferred.

Especially preferably, the support is a porous material so that the complex may be loaded into the pores of the particulate support, e.g. using a process analogous to those described in WO94/14856, WO95/12622, WO2006/097497 and EP1828266.

The average particle size of the support such as silica support can be typically from 10 to 100 μm. The average particle size (i.e. median particle size, D₅₀) may be determined using the laser diffraction particle size analyser Malvern Mastersizer 3000, sample dispersion: dry powder.

The average pore size of the support such as silica support can be in the range 10 to 100 nm and the pore volume from 1 to 3 mL/g.

Examples of suitable support materials are, for instance, ES757 produced and marketed by PQ Corporation, Sylopol 948 produced and marketed by Grace or SUNSPERA DM-L-303 silica produced by AGC Si-Tech Co. Supports can be optionally calcined prior to the use in catalyst preparation in order to reach optimal silanol group content.

The catalyst can contain from 5 to 500 μmol, such as 10 to 100 μmol of transition metal per gram of support such as silica, and 3 to 15 mmol of Al per gram of support such as silica.

### Multimodal Polyethylene Polymer

The present invention concerns the preparation of a multimodal polyethylene homopolymer or copolymer. The density of the multimodal ethylene homopolymer or copolymer may be between 900 and 980 kg/m³, preferably 905 to 940 kg/m³, especially 910 to 935 kg/m³.

It is preferred if the multimodal polyethylene polymer is a copolymer. More preferably, the multimodal polyethylene copolymer is an LLDPE. It may have a density of 905 to 940 kg/m³, preferably 910 to 935 kg/m³, more preferably 915 to 930 kg/m³, especially of 916 to 928 kg/m³. In one embodiment a range of 910 to 928 kg/m³ is preferred. The term LLDPE used herein refers to linear low density polyethylene. The LLDPE is preferably multimodal.

The term “multimodal” includes polymers that are multimodal with respect to MFR and includes also therefore bimodal polymers. The term “multimodal” may also mean multimodality with respect to the “comonomer distribution”.

Usually, a polymer comprising at least two polyethylene fractions, which have been produced under different polymerisation conditions resulting in different (weight average) molecular weights and molecular weight distributions for the fractions, is referred to as “multimodal”. The prefix “multi” relates to the number of different polymer fractions present in the polymer. Thus, for example, the term multimodal polymer includes so called “bimodal” polymers consisting of two fractions. The form of the molecular weight distribution curve, i.e. the appearance of the graph of the polymer weight fraction as a function of its molecular weight, of a multimodal polymer, e.g. LLDPE, may show two or more maxima or at least be distinctly broadened in comparison with the curves for the individual fractions. Often the final MWD curve will be broad, skewered or displaying a shoulder.

Ideally, the molecular weight distribution curve for multimodal polymers of the invention will show two distinct maxima. Alternatively, the polymer fractions have similar MFR and are bimodal in the comonomer content. A polymer comprising at least two polyethylene fractions, which have been produced under different polymerisation conditions resulting in different comonomer content for the fractions, is also referred to as “multimodal”.

For example, if a polymer is produced in a sequential multi-stage process, utilising reactors coupled in series and using different conditions in each reactor, the polymer fractions produced in the different reactors will each have their own molecular weight distribution and weight average molecular weight. When the molecular weight distribution curve of such a polymer is recorded, the individual curves from these fractions are superimposed into the molecular weight distribution curve for the total resulting polymer product, usually yielding a curve with two or more distinct maxima.

In any multimodal polymer, there may be a lower molecular weight component (LMW) and a higher molecular weight component (HMW). The LMW component has a lower molecular weight than the higher molecular weight component. This difference is preferably at least 5000 g/mol.

The multimodal polyethylene polymer produced by the present process preferably comprises at least one C4-10-comonomer. Comonomers may be present in the HMW component (or second component (B), produced in the second polymerisation step) or the LMW component (or first component (A), produced in the first polymerisation step) or both. From hereon, the term LMW/HMW component will be used but the described embodiments apply to the first and second components respectively.

It is preferred if the HMW component comprises at least one C4-10-comonomer. The LMW component may then be an ethylene homopolymer or may also comprise at least one C4-10-comonomer. In one embodiment, the multimodal polyethylene polymer contains a single comonomer. In a preferred embodiment, the multimodal polyethylene polymer comprises at least two, e.g. exactly two, C4-10 comonomers.

The overall comonomer content in the multimodal polyethylene polymer may be for example 0.2 to 14.0% by mol, preferably 0.3 to 12% by mol, more preferably 0.5 to 10.0% by mol and most preferably 0.6 to 8.5% by mol.

1-Butene may be present in an amount of 0.05 to 6.0% by mol, such as 0.1 to 5% by mol, more preferably 0.15 to 4.5% by mol and most preferably 0.2 to 4% by mol.

The C6 to C10 alpha olefin may be present in an amount of 0.2 to 6% by mol, preferably 0.3 to 5.5% by mol, more preferably 0.4 to 4.5% by mol.

Preferably, the LMW component has lower amount (mol %) of comonomer than the HMW component, e.g. the amount of comonomer, preferably of 1-butene in the LMW component is from 0.05 to 0.9 mol %, more preferably from 0.1 to 0.8 mol %, whereas the amount of comonomer, preferably of 1-hexene in the HMW component (B) is from 1.0 to 8.0 mol %, more preferably from 1.2 to 7.5 mol %.

The LMW component of the multimodal polyethylene polymer may have a MFR2 of 0.5 to 3000 g/10 min, more preferably 1.0 to 1000 g/10 min. In some embodiments, the MFR2 of the LMW component may be 50 to 3000 g/10 min, more preferably 100 to 1000 g/10 min, e.g. where the target is a cast film.

The molecular weight (Mw) of the LMW component should preferably range from 20,000 to 180,000, e.g. 40,000 to 160,000. It may have a density of at least 925 kg/m³, e.g. at least 940 kg/m³. A density in the range of 930 to 950 kg/m³, preferably of 935 to 945 kg/m³ is possible.

The HMW component of the multimodal polyethylene polymer may, for example, have an MFR2 of less than 1 g/10 min, such as 0.2 to 0.9 g/10 min, preferably of 0.3 to 0.8 and more preferably of 0.4 to 0.7 g/10 min. It may have a density of less than 915 kg/m³, e.g. less than 910 kg/m³, preferably less than 905 kg/m³. The Mw of the higher molecular weight component may range from 70,000 to 1,000,000, preferably 100,000 to 500,000.

The LMW component may form 30 to 70 wt % of the multimodal polyethylene polymer such as 35 to 65 wt %, especially 38 to 62 wt %.

The HMW component may form 30 to 70 wt % of the multimodal polyethylene polymer such as 35 to 65 wt %, especially 38 to 62 wt %.

In one embodiment, there is 40 to 45 wt % of the LMW component and 60 to 55 wt % of the HMW component.

In one embodiment, the polyethylene polymer consists of the HMW and LMW components as the sole polymer components.

The multimodal polyethylene polymer of the invention may have a MFR2 of 0.01 to 50 g/10 min, preferably 0.05 to 25 g/10 min, especially 0.1 to 10 g/10 min.

### EXAMPLES

### Catalyst

### Loading of SiO₂:

10 kg of silica (PQ Corporation ES757, calcined 600° C.) was added from a feeding drum and inertized in the reactor until O₂ level below 2 ppm was reached.

### Preparation of MAO/tol/MC:

30 wt % MAO in toluene (14.1 kg) was added into another reactor from a balance followed by toluene (4.0 kg) at 25° C. (oil circulation temp) and stirring 95 rpm. Stirring speed was increased 95 rpm->200 rpm after toluene addition, stirring time 30 min. Metallocene Rac-dimethylsilanediylbis{2-(5-(trimethylsilyl)furan-2-yl)-4,5-dimethylcyclopentadien-1-yl}zirconium dichloride 477 g was added from a metal cylinder followed by flushing with 4 kg toluene (total toluene amount 8.0 kg). Reactor stirring speed was changed to 95 rpm for MC feeding and returned back to 200 rpm for 3 h reaction time. After reaction time MAO/tol/MC solution was transferred into a feeding vessel.

### Preparation of Catalyst:

Reactor temperature was set to 10° C. (oil circulation temp) and stirring 40 rpm for MAO/tol/MC addition. MAO/tol/MC solution (target 22.5 kg, actual 22.2 kg) was added within 205 min followed by 60 min stirring time (oil circulation temp was set to 25° C.). After stirring “dry mixture” was stabilised for 12 h at 25° C. (oil circulation temp), stirring 0 rpm. Reactor was turned 20° (back and forth) and stirring was turned on 5 rpm for few rounds once an hour.

After stabilisation the catalyst was dried at 60° C. (oil circulation temp) for 2 h under nitrogen flow 2 kg/h, followed by 13 h under vacuum (same nitrogen flow with stirring 5 rpm). Dried catalyst was sampled and HC content was measured in the glove box with Sartorius Moisture Analyser, (Model MA45) using thermogravimetric method. Target HC level was <2% (actual 1.3%).

### Example 1 (Comparative)

A single-site catalyst, having an initial size of 25 microns, span of 1.6 and apparent density of 1.8 kg/m³ was used to produce LLDPE film. The catalyst was first prepolymerised in a prepolymerisation reactor at T=50° C. and P=65 barg. More specifically, 900 kg/h of ethylene, 95 kg of 1-butene per tn ethylene, 0.27 Kg hydrogen per tn of propane and 6.50 tn propane/h (diluent) were fed to prepoly reactor and the mean residence time was 30 mins. The product was transferred to a split loop reactor having volume equal to 80 m3. Ethylene (C2), propane (diluent), 1-butene (C4) and hydrogen (H2) were fed to the reactors and the polymerisation conditions were T=85° C., P=64 barg and the mean residence time was equal to 1.0 h. The molar ratio of H2/C2 and C4/C2 were 2 mol/kmol and 100 mol/kmol, respectively, and the overall production rate in the loop reactor was 25 tn/h (the overall productivity was 2.5 kg/gcat). Then, the material flashed out in a high-pressure separator, which operating pressure has been selected to be equal to 2 barg and the estimated residence time was equal to 5 mins. Subsequently, the polymer particles were transferred to the gas-phase reactor having overall volume equal to 350 m³ (including the disengagement zone) that operated at overall pressure of 20 barg, temperature of 75° C. and having gas phase composition of 52.5% mol propane, 10% mol nitrogen, 32.5% mol ethylene, 5% mol C6 and H2/C2=0.5 mol/kmol. The overall residence time in the GPR has been 2.8 hours. The superficial gas velocity in the gas phase reactor has been selected to be 0.45 m/s.

A cyclone has been placed at the exit of the disengagement zone (recirculation gas pipe) to collect the entrained particles (estimate the particles carry over) as well as to prevent small size particles going through the gas compressor and heat exchanger.

The overall catalyst productivity in GPR was 3.5 kg/gcat (3 days average). The production split value was equal to 55%. It has been measured that the solids carry over has been 220 kg/h. The operation of GPR has been interrupted and finally led to shut down after 3 days of operation due to sheeting and chunking issues.

### Example 2 (Comparative)

The procedure of Example 1 was repeated with the exception that the operating pressure in the high-pressure separator has been selected to be equal to 7 barg and the estimated residence time was equal to 5 mins.

The overall catalyst productivity in GPR was 3.5 kg/gcat (12 days average). The production split value was equal to 55%. It has been measured that the solids carry over has been 160 kg/h. The operation of GPR has been interrupted and finally led to shut down after 12 days of operation due to sheeting and chunking issues.

### Example 3 (Inventive)

The procedure of Example 1 was repeated with the exception that the operating pressure in the high-pressure separator has been selected to be equal to 10 barg and the estimated residence time was equal to 5 mins.

The overall catalyst productivity in GPR was 3.5 kg/gcat. The production split value was equal to 55%. It has been measured that the solids carry over has been 22 kg/h. The operation of GPR has been smooth for 20 days of operation.

### Example 4 (Inventive)

The procedure of Example 1 was repeated with the exception that the operating pressure in the high-pressure separator has been selected to be equal to 15 barg and the estimated residence time was equal to 5 mins.

The overall catalyst productivity in GPR was 3.5 kg/gcat. The production split value was equal to 55%. It has been measured that the solids carry over has been 9 kg/h. The operation of GPR has been smooth for 20 days of operation.

Table 1 summarizes the examples outcome.

TABLE 1
Summary of the results.

| | Flash | Flash residence | Entrainment | GPR |
|---|---|---|---|---|
| Example | pressure (bar) | time (min) | (Kg/h) | Operability |
| CE1 | 2 | 5 | 220 | Unstable |
| CE2 | 7 | 5 | 160 | Unstable |
| IE1 | 10 | 5 | 22 | Smooth |
| IE2 | 15 | 5 | 9 | Smooth |

### Example 5 (Comparative)

A single site catalyst, having an initial size of 25 microns, span of 1.6 and apparent density of 1.8 kg/m³ was used to produce LLDPE film. The catalyst was first prepolymerised in a prepolymerisation reactor at T=50° C. and P=65 barg. More specifically, 900 kg/h of ethylene, 95 kg of 1-butene per tn ethylene, 0.27 Kg hydrogen per tn of propane and 6.50 tn propane/h (diluent) were fed to prepoly reactor and the mean residence time was 30 mins. The product was transferred to a split loop reactor having volume equal to 80 m³. Ethylene (C2), propane (diluent), 1-butene (C4) and hydrogen (H2) were fed to the reactors and the polymerisation conditions were T=85° C., P=64 barg and the mean residence time was equal to 1.0 h. The molar ratio of H2/C2 and C4/C2 were 5 mol/kmol and 40 mol/kmol, respectively, and the overall production rate in the loop reactor was 25 tn/h (the overall productivity was 2.5 kg/gcat), the density of the produced polymer has been 955 kg/m³, MFR2 75 and crystallinity of 67% wt. Then, the material flashed out in a high-pressure separator, which operating pressure has been selected to be equal to 2 barg and the estimated residence time was equal to 5 mins. Subsequently, the polymer particles were transferred to the gas-phase reactor having overall volume equal to 350 m³ (including the disengagement zone) that operated at overall pressure of 20 barg, temperature of 75° C. and having gas phase composition of 52.5% mol propane, 10% mol nitrogen, 32.5% mol ethylene, 5% mol C6 and H2/C2=0.5 mol/kmol. The overall residence time in the GPR has been 2.8 hours. The superficial gas velocity in the gas phase reactor has been selected to be 0.45 m/s.

A cyclone has been placed at the exit of the disengagement zone (recirculation gas pipe) to collect the entrained particles (estimate the particles carry over) as well as to prevent small size particles going through the gas compressor and heat exchanger.

The overall catalyst productivity in GPR was 3.5 kg/gcat (2 days average). The production split value was equal to 55%. It has been measured that the solids carry over has been 280 kg/h. The operation of GPR has been interrupted and finally led to shut down after 2 days of operation due to sheeting and chunking issues associated to the solids carry over phenomena.

### Example 6 (Comparative)

The procedure of Example 5 was repeated with the exception that the operating pressure in the high-pressure separator has been selected to be equal to 10 barg and the estimated residence time was equal to 5 mins.

The overall catalyst productivity in GPR was 3.5 kg/gcat (10 days average). The production split value was equal to 55%. It has been measured that the solids carry over has been 190 kg/h. The operation of GPR has been interrupted and finally led to shut down after 10 days of operation due to sheeting and chunking issues associated to the solids carry over phenomena.

### Example 7 (Comparative)

The procedure of Example 5 was repeated with the exception that the operating pressure in the high-pressure separator has been selected to be equal to 15 barg and the estimated residence time was equal to 5 mins.

The overall catalyst productivity in GPR was 3.5 kg/gcat. The production split value was equal to 55%. It has been measured that the solids carry over has been 80 kg/h. The operation of GPR has been smooth for 15 days of operation and it as interrupted after 18 days of operation due to sheeting and chunking issues associated to the solids carry over phenomena.

### Example 8 (Inventive)

The procedure of Example 1 was repeated with the exception that the operating pressure in the high-pressure separator has been selected to be equal to 15 barg and the estimated residence time was equal to 12 mins.

The overall catalyst productivity in GPR was 3.5 kg/gcat. The production split value was equal to 55%. It has been measured that the solids carry over has been 6 kg/h. The operation of GPR has been smooth for 20 days of operation.

### Example 9 (Comparative)

A single site catalyst, having an initial size of 25 microns, span of 1.6 and apparent density of 1.8 kg/m³ was used to produce LLDPE film. The catalyst was first prepolymerised in a prepolymerisation reactor at T=50° C. and P=65 barg. More specifically, 900 kg/h of ethylene, 95 kg of 1-butene per tn ethylene, 0.27 Kg hydrogen per tn of propane and 6.50 tn propane/h (diluent) were fed to prepoly reactor and the mean residence time was 30 mins. The product was transferred to a split loop reactor having volume equal to 80 m³. Ethylene (C2), propane (diluent), 1-butene (C4) and hydrogen (H2) were fed to the reactors and the polymerisation conditions were T=85° C., P=64 barg and the mean residence time was equal to 1.0 h. The molar ratio of H2/C2 and C4/C2 were 6 mol/kmol and 20 mol/kmol, respectively, and the overall production rate in the loop reactor was 25 tn/h (the overall productivity was 2.5 kg/gcat), the density of the produced polymer has been 965 kg/m³, MFR2 85 and crystallinity of 75% wt. Then, the material flashed out in a high-pressure separator, which operating pressure has been selected to be equal to 2 barg and the estimated residence time was equal to 5 mins. Subsequently, the polymer particles were transferred to the gas-phase reactor having overall volume equal to 350 m³ (including the disengagement zone) that operated at overall pressure of 20 barg, temperature of 75° C. and having gas phase composition of 52.5% mol propane, 10% mol nitrogen, 32.5% mol ethylene, 5% mol C6 and H2/C2=0.5 mol/kmol. The overall residence time in the GPR has been 2.8 hours. The superficial gas velocity in the gas phase reactor has been selected to be 0.45 m/s.

A cyclone has been placed at the exit of the disengagement zone (recirculation gas pipe) to collect the entrained particles (estimate the particles carry over) as well as to prevent small size particles going through the gas compressor and heat exchanger.

The overall catalyst productivity in GPR was 3.5 kg/gcat (2 days average). The production split value was equal to 55%. It has been measured that the solids carry over has been 330 kg/h. The operation of GPR has been interrupted and finally led to shut down after 1 day of operation due to sheeting and chunking issues associated to the solids carry over phenomena.

### Example 10 (Comparative)

The procedure of Example 9 was repeated with the exception that the operating pressure in the high-pressure separator has been selected to be equal to 10 barg and the estimated residence time was equal to 5 mins.

The overall catalyst productivity in GPR was 3.5 kg/gcat (10 days average). The production split value was equal to 55%. It has been measured that the solids carry over has been 240 kg/h. The operation of GPR has been interrupted and finally led to shut down after 7 days of operation due to sheeting and chunking issues associated to the solids carry over phenomena.

### Example 11 (Comparative)

The procedure of Example 9 was repeated with the exception that the operating pressure in the high-pressure separator has been selected to be equal to 15 barg and the estimated residence time was equal to 5 mins.

The overall catalyst productivity in GPR was 3.5 kg/gcat. The production split value was equal to 55%. It has been measured that the solids carry over has been 120 kg/h. The operation of GPR has been smooth for 10 days of operation and it as interrupted after 11 days of operation due to sheeting and chunking issues associated to the solids carry over phenomena.

### Example 12 (Inventive)

The procedure of Example 1 was repeated with the exception that the operating pressure in the high-pressure separator has been selected to be equal to 15 barg and the estimated residence time was equal to 12 mins.

The overall catalyst productivity in GPR was 3.5 kg/gcat. The production split value was equal to 55%. It has been measured that the solids carry over has been 7 kg/h. The operation of GPR has been smooth for 20 days of operation.

Table 2 summarizes the examples outcome.

TABLE 2
Summary of the results.

| | Material properties | Flash | Flash | Entrain- | GPR |
|---|---|---|---|---|---|
| Exam- | in loop (density | pressure | residence | ment | Oper- |
| ple | crystallinity) | (bar) | time (min) | (Kg/h) | ability |
| CE5 | 955 kg/m³, 67% wt | 2 | 5 | 280 | Unstable |
| CE6 | 955 kg/m³, 67% wt | 10 | 5 | 190 | Unstable |
| CE7 | 955 kg/m³, 67% wt | 15 | 5 | 80 | Unstable |
| CE9 | 965 kg/m³, 75% wt | 2 | 5 | 330 | Unstable |
| CE10 | 965 kg/m³, 75% wt | 10 | 5 | 240 | Unstable |
| CE11 | 965 kg/m³, 75% wt | 15 | 5 | 120 | Unstable |
| IE8 | 955 kg/m³, 67% wt | 15 | 12 | 6 | Smooth |
| IE12 | 965 kg/m³, 75% wt | 15 | 12 | 7 | Smooth |

1. A process for polymerising olefins in multi stage polymerisation process configuration, the process comprising:
a) polymerising in a first polymerisation step a first olefin monomer, optionally in the presence of at least one other alpha olefin comonomer, in the presence of a metallocene polymerisation catalyst so as to form a first polymer component (A); and
b) transferring the first polymer component (A) into a separation unit to remove low molecule penetrants and to obtain separated solid polyolefin particles of the first polymer component (A*); and
c) polymerising in gas phase in a second polymerisation step a second olefin monomer, optionally in the presence of at least one other alpha olefin comonomer in the presence of the separated solid polyolefin particles (A*) of step b), so as to form a second polymer component (B).

2. The process as claimed in claim 1, wherein the separation unit is operated under 1 to 25 bar, within the range of 40 to 90° C., and an average residence time of particulate matter in the separation unit is within the range of 2 to 30 min.

3. The process as claimed in claim 1, wherein the low molecule penetrant is one or more selected from a group consisting of alpha C2-6-olefins, C2-6-alkanes and chain transfer agents.

4. The process as claimed in claim 3, wherein the low molecule penetrant is selected from a group consisting of ethylene, 1-butene, 1-hexene, propane, hydrogen and any mixtures thereof.

5. The process according to claim 1, wherein the metallocene polymerisation catalyst is a single-site catalyst.

6. The process according to claim 1, wherein the metallocene polymerisation catalyst comprises (i) a transition metal complex, (ii) a cocatalyst, and optionally (iii) a support.

7. The process as claimed in claim 1, wherein the separation step b) is performed in one or more flash separators.

8. The process as claimed in claim 7, wherein the flash separator(s) is/are operated at a pressure within the range of 1 to 25 bar.

9. The process as claimed in claim 7, wherein the flash separator(s) is/are operated at a temperature within the range of 40 to 90° C.

10. The process as claimed claim 7, wherein particulate matter has an average residence time in the flash separator is within the range of 2 to 30 min.

11. A method for improving performance of a metallocene polymerisation catalyst in a multi-stage olefin polymerisation, wherein a first polymer component (A) produced in a first polymerisation step is transferred into a separation unit to remove low molecule penetrants and to obtain separated solid polyolefin particles of the first polymer component (A*) prior to transferring the obtained separated solid polyolefin particles of the first polymer component (A*) to a further polymerisation step.

12. The method as claimed in claim 11, wherein the separation is performed in one or more flash separators.

13. The method as claimed in claim 12, wherein the flash separator(s) is/are operated at a pressure within the range of 1 to 25 bar.

14. The method as claimed in claim 12, wherein the flash separator(s) is/are operated at a temperature within the range of 40 to 90° C.

15. The method as claimed in claim 12, wherein particulate matter has an average residence time in the flash separator within the range of 2 to 30 min.
